(19) United States
(12) Patent Application Publication
(10) Pub. No.: US 2011/0270915 A1
(43) Pub. Date: Nov. 3, 2011

(54) SYSTEM COMPRISING A SERVER AND A TERMINAL PROVIDED WITH GRAPHICAL INTERFACES COMMUNICATING VIA AN IMAGE-SHARING PROTOCOL

(75) Inventor: Jean-Pierre Morard, Rueil-Malmalson (FR)

(73) Assignee: SAGEMCOM BROADBAND SAS, Rueil Malmaison (FR)

(21) Appl. No.: 13/142,533

(22) PCT Filed: Dec. 2, 2009
(86) PCT No.: PCT/FR2009/052380

§ 371 Date: Jul. 22, 2011

(30) Foreign Application Priority Data
Dec. 30, 2008 (FR) 0859116

(51) Int. Cl. G06F 15/16

(52) U.S. Cl. 709/203

(57) ABSTRACT

A multimedia system includes a server including an operating system configured to allocate resources thereof to software applications, the activation of which determined by a control application; a client terminal including a display device and a remote control, the server and the client terminal including a first graphical interface and a second graphical interface; respectively, configured to communicate via an image-sharing protocol; the first interface configured to identify a plurality of commands related to a control application thereof in signals transmitted by the terminal via the first and second graphical interfaces so as to follow the commands, and to generate an image particular to the control application, so as to transmit the image to the terminal via the first and second graphical interfaces.

### TECHNICAL FIELD OF THE INVENTION

The present invention relates to a multimedia system comprising a server and a terminal provided with graphical interfaces communicating via an image-sharing protocol, particularly for a computer-type server and a television-type terminal.

The server, generally a computer, is linked to the client terminal, for example a video decoder integrated in the television, by a network, for example in HDMI (High Definition Multimedia Interface), WIFI or ethernet form. The computer screen may then be displayed by the client terminal on a television screen according to a VNC (Virtual Networking Computing) protocol.

### BACKGROUND OF THE INVENTION

In this sort of system, it is known that the server decodes what it receives from a telecommunications network or a numerical support before sending it to the client terminal. To decompress, the server captures its own display, encodes it and sends it via the network to the client terminal.

Each image for display is stored in a memory bufferknown as a framebuffer in the server and is generally encoded in RGB (Red Green Blue) format, which is the most direct way of encoding the images, the three layers corresponding to the three primary colours red, green and blue.

The image is then generally transformed into YUV (or luminance—chrominance) format. From signals received in YUV format, the client terminal is then able to display the images thereby transmitted.

In summary, each of the system elements—server or client terminal—uses its own display protocol that is adapted to its signal processing means.

The present invention results from the recognition that the implementation of this sort of system does not allow a user to control its operation in a simple, user-friendly manner.

In reality, the server is traditionally a computer capable of offering various services, such as accessing e-mails, surfing the Internet and, in general terms, any sort of computer application that is possible with its hardware and software.

However, the man-machine interface particular to a computer, typically made up of a keyboard and a mouse, does not generally include means enabling it to be controlled from the client terminal, where the man-machine interface is particularly user-friendly, especially through the use of a large-sized display screen (flat-screen type) and a remote control enabling certain functions to be controlled from a distance.

Moreover, even when the server's man-machine interface allows a large-sized display screen and remote control, the end user is obliged to use a plurality of screens and remote controls—one for the server and one for the client terminal—which makes the system control complex.

### GENERAL DESCRIPTION OF THE INVENTION

In this context, the present invention aims to provide a system with an easy, user-friendly method of control. This is why the invention relates to a multimedia system including:
a server provided with an operating system managing the allocation of the resources thereof to software applications, the activation of which can be determined by a control application and
a client terminal provided with a display device and a remote control, the server and client terminal being provided with a first graphical interface and a second graphical interface, respectively, communicating via an image-sharing protocol,
   characterised in that the server includes:
means of identifying commands related to the control application thereof in signals transmitted by the terminal via the graphical interfaces so as to follow said commands and
means of generating an image particular to the control application, so as to transmit said image to the terminal via the graphical interfaces.

Thanks to the invention, a user may implement the man-machine interface of their client terminal to control the associated server operation.

In fact, the use of an image-sharing protocol enables the terminal to display images emanating from the server control application, such that the user-friendliness of the terminal's man-machine interface—large-sized screen and remote control—can be implemented to manage this control application and therefore the set of server applications. Hence, the entire system control is simplified and made more user-friendly, as the user is able to control two system elements—the server and the terminal—from the same unique interface.

The device according to the invention may likewise present one or more of the following characteristics, considered individually or according to all technically possible combinations.

According to one embodiment, the server's means of identifying commands related to the control application conform to the RFB image-sharing protocol.

In one embodiment, the server's means of identifying commands are able to follow these commands, so as to deactivate an active application by means of the control application.

According to one embodiment, the server's means of identifying commands are able to follow these commands, so as to activate at least one application by means of the control application.

In one embodiment, the server means of generating an image particular to the control application are able to represent, firstly, active applications and, secondly, disabled applications.

According to one embodiment, the first graphical interface and the second graphical interface include means of encoding their communication, according to an image-sharing protocol, with a data transmission protocol particular to a telecommunication network.

In one embodiment, the terminal includes encoding means in signals transmitted to the server of commands issued by the remote control.

The invention likewise relates to a server for a multimedia system including an operating system managing the allocation of the resources thereof to software applications, the activation of which can be determined by a control application, this server likewise including a first graphical interface intended to communicate via an image-sharing protocol with a second graphical interface of a client terminal, characterised in that the system, conforming to one of the preceding embodiments, includes:
means of identifying commands related to the control application thereof in signals transmitted by the terminal via its graphical interface, so as to follow said commands and
means of generating an image particular to the control application, so as to transmit this image to the terminal via its graphical interface.

The invention likewise relates to a client terminal intended for a multimedia system including a display device, a remote control and a second graphical interface communicating via an image-sharing protocol with a first graphical interface of a server,

characterised in that the server, being in accordance with the invention, includes:
means of displaying an image particular to the control application of the server transmitted via these graphical interfaces and
means of encoding commands related to the control application of the server in signals transmitted to this server via the graphical interfaces.

Finally, the invention likewise relates to a management method for a multimedia system including:
a server provided with an operating system managing the allocation of the resources thereof to software applications, the activation of which may be determined by a control application and
a client terminal provided with a display device and a remote control, the server and the client terminal being provided with a first graphical interface and a second graphical interface, respectively, communicating via an image-sharing protocol,
   characterised in that it comprises the following stages:
the stage for the server to identify commands related to its control application in signals transmitted by the terminal via graphical interfaces so as to follow said commands,
the stage for the server to generate an image particular to the control application so as to transmit this image to the terminal via the graphical interfaces and
the stage for the terminal to display the image particular to the control application of the server transmitted via these graphical interfaces and
the stage for the terminal to encode commands related to the control application of the server in signals transmitted to said server via the graphical interfaces in a system according to the invention.

### BRIEF DESCRIPTION OF THE FIGURES

Other characteristics and advantages of the invention will clearly emerge from the description given of them below, intended by way of example and in no way as limiting, with reference to the attached figures in which:

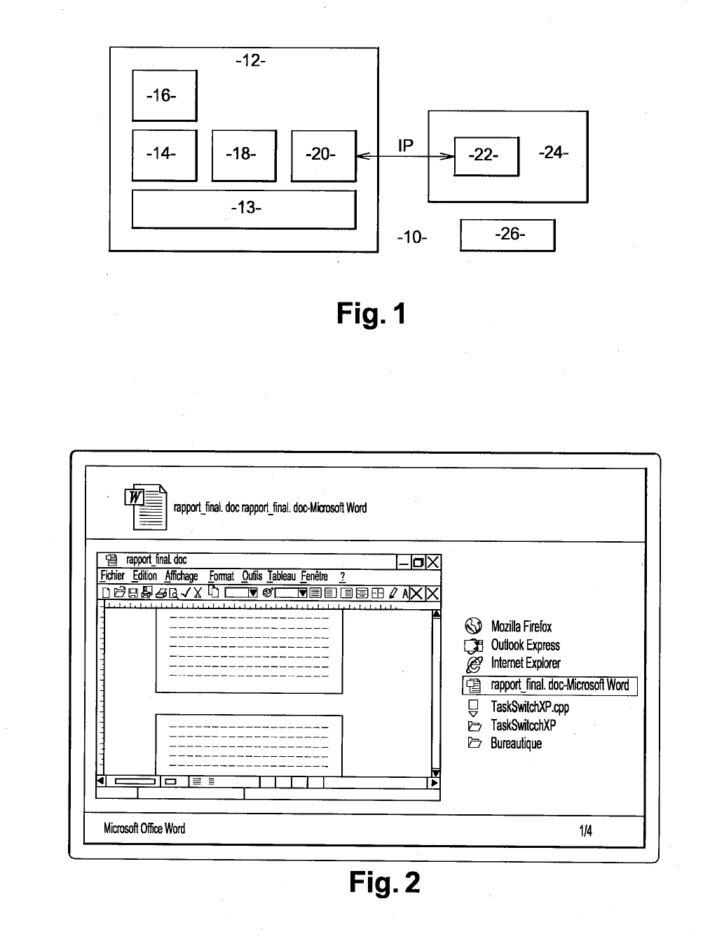

A system according to the invention is represented in schematic form in FIG. 1,

An image supplied by a terminal screen according to the invention is illustrated in FIG. 2.

### DESCRIPTION OF THE PREFERRED EMBODIMENTS OF THE INVENTION

With reference to FIG. 1, a multimedia system 10 according to the invention includes at least two elements, namely:
a server 12 provided with an operating system 13 managing the allocation of the resources of the server to software applications 14 and/or 16. By way of example, Linux™ or Windows™ are these sorts of operating systems 13, the latter enabling software applications to be supported, such as Internet Explorer for browsing Web contents or Outlook for processing e-mails.

These software applications may be directly activated or deactivated by a user or, alternatively, by a control application 18. In the case of an operating system working on Windows™, this sort of control application may be opened by pressing the <Ctrl>, <Alt>, <Del> keys.
a client terminal 24 provided with a display device and a remote control 26. As described above, the display device is typically a television screen provided with a remote control.

In accordance with the invention, the server 12 and the client terminal 24 are provided with a first graphical interface 20 and a second graphical interface 22, respectively, communicating via an image-sharing protocol.

In this embodiment, this graphical interface is the RFB or “Remote Frame Buffer” protocol, a remote access protocol to graphical interfaces.

This protocol operates at the memory buffer level of the image and may be applied to all systems using windows, in other words, dimensioning the image, including Windows and Macintosh. The RFB standard implemented in the embodiment of the invention is standard RFB3.8, dating back to June 2007 and available at:

http://www.realnvnc.com/docs/rfbproto.pdf

The RFB protocol is a simple command-based protocol indicating a rectangle of pixels to be inserted at a given position in the image, which increases the ease of implementation of the invention, according to which the server 12 likewise includes:
means 20 of identifying commands related to their control application 18 in signals transmitted by the terminal via graphical interfaces 20 and 22 so as to follows said commands and
means 20 of generating an image particular to the control application so as to transmit this image to the terminal 24 via the graphical interfaces 20 and 22.

Hence, a user may take control of the server 12 applications 14 and 16 from the terminal 24, namely by means of the control application 18 managed via the graphical interfaces 20 and 22.

It should be remembered that this sort of control application 18 determines exclusively or by priority the lifecycle of the other server applications.

In this example, the control application makes it possible to access a list of current applications—possibly to close them down, a list of applications that have been closed down, possibly to activate them. In other words, the means of generating an image particular to the control application 18 are able to represent, firstly, the active applications and, secondly, the deactivated applications, as illustrated in FIG. 2.

For its part, the client terminal 24 includes means 20 of displaying this image 30, particular to the control application 18 of the server 20, in such a way that its user may be visually aware of the state of activity of his server.

In addition, the client terminal includes means 22 of encoding commands relating to the control application 18 of the server 20 in signals transmitted to said server 20 by the graphical interfaces 20 and 22.

The present invention is open to numerous variants. Hence, in this embodiment, a remote control 26 of the client terminal is implemented to manage the control application 18 of the server, which increases the user-friendliness of the system and the simplicity of it man-machine interface. However, use of this remote control is not strictly necessary for the implementation of the invention.

Likewise, numerous variants are possible to ensure communications between the graphical interfaces. Hence, in this embodiment, the Internet protocol (IP) is implemented, but other protocols may be used.

Different implementation stages of the invention are detailed below by way of example:

During initialisation, the server 12 may send a <Server Initialisation> message to the terminal 24, which gives the client:
the width of the memory buffer,
the height of the memory buffer,
the format of the pixels in the image concerned,
a name associated with the server desktop,
   as shown in the table below.

| No. of bytes | Type | [Value] | Description |
|---|---|---|---|
| 2 | U16 | | framebuffer-width |
| 2 | U16 | | framebuffer-height |
| 16 | PIXEL_FORMAT | | server-pixel- |
| | | | format |
| 4 | U32 | | name-length |
| name-length | U8 array | | name-string |

In this table, the <Server-pixel-format> command specifies the server's natural pixel format. It is the format used except where the terminal 24, sends a <SetPixelFormat> message to specify a different format.

The <PIXEL_FORMAT> command is defined as follows:

| No. of bytes | Type | [Value] | Description |
|---|---|---|---|
| 1 | U8 | | bits |
| 1 | U8 | | depth |
| 1 | U8 | | big-endian-flag |
| 1 | U8 | | true-colour-flag |
| 2 | U16 | | red-max |
| 2 | U16 | | green-max |
| 2 | U16 | | blue-max |
| 1 | U8 | | red-shift |
| 1 | U8 | | green-shift |
| 1 | U8 | | blue-shift |
| 3 | | | padding |

Messages may then be transmitted from the terminal 24 to the server 12. For example, a <SetPixelFormat> command, which defines the format of the pixels that the client wishes to receive from the server.

If the client does not require a specific format, it is the server's natural format that will be used (defined during initialisation).

| No. of bytes | Type | [Value] | Description |
|---|---|---|---|
| 1 | U8 | 0 | message-type |
| 3 | | | padding |
| 16 | PIXEL_FORMAT | | pixel-format |

Another type of command is <SetEncodings>, which defines the type of encoding of pixels sent by the server.

| Number | Name |
|---|---|
| 0 | Raw |
| 1 | CopyRect |
| 2 | RRE |
| 4 | CoRRE (deprecated) |
| 5 | Hextile |
| 16 | ZRLE |

Another type of command is <FramebufferUpdateRequest>, which notifies the server 12 that the terminal 24 is interested in a memory buffer zone specified by x-position and y-position coordinates, a width and a height.

The server 12 responds to a <FramebufferUpdateRequest> message with a <FramebufferUpdate> message.

| No. of bytes | Type | [Value] | Description |
|---|---|---|---|
| 1 | U8 | 3 | message-type |
| 1 | U8 | | incremental |
| 2 | U16 | | x-position |
| 2 | U16 | | y-position |
| 2 | U16 | | width |
| 2 | U16 | | height |

Another command used is <KeyEvent>, which corresponds to a key stroke. The value of the keys is then defined by a <keysymdef.h> configuration file implemented in the X Window™ environment concerned for this embodiment.

Finally, it should be noted that in order to allow satisfactory control of the server from the terminal, certain server keys may be transcribed with identified hexadecimal values, thereafter by means of the remote control 26.

By way of example, the following values correspond to keys:

| | Keysym | | Keysym |
|---|---|---|---|
| Key name | value | Key name | value |
| BackSpace | Oxff08 | F1 | Oxffbe |
| Tab | Oxff09 | F2 | Oxffbf |
| Return or | Oxff0d | F3 | Oxffc0 |
| Enter | | | |
| Escape | Oxff1b | F4 | Oxffc1 |
| Insert | Oxff63 | . . . | . . . |
| Delete | Oxffff | F12 | Oxffc9 |
| Home | Oxff50 | Shift | Oxffe1 |
| | | (left) | |
| End | Oxff57 | Shift | Oxffe2 |
| | | (right) | |
| Page Up | Oxff55 | Control | Oxffe3 |
| | | (left) | |
| Page Down | Oxff56 | Control | Oxffe4 |
| | | (right) | |
| Left | Oxff51 | Meta | Oxffe7 |
| | | (left) | |
| Up | Oxff52 | Meta | Oxffe8 |
| | | (right) | |
| Right | Oxff53 | Alt (left) | Oxffe9 |
| Down | Oxff54 | Alt | Oxffea |
| | | (right) | |

The commands sent by the remote control enable server software applications to be controlled via its control application. To this end, certain commands are common to all controlled applications, for example commands intended to allow navigation through the menu displaying active applications and inactive applications, as shown in FIG. 2.

However, other commands may be specific to an application being displayed. For example:
the <P+/P−> keys, normally used to change the program concerned by the terminal, may be used to change the tab in a software application capable of presenting a plurality of tabs, such as Microsoft Internet Explorer™.
the <−/−> keys normally used to move a screen selection may be used for the tab and back functions or to move a page on or back in a software application capable of displaying several pages, such as Microsoft Internet Explorer™.
the <Play>, <Pause>, <Stop>, <Rewind> keys normally used to control a video recorder associated with the terminal, may be used to manage a server software application intended to reproduce multimedia contents, such as Microsoft Windows Media Player™.

In other words, the terminal and/or the server must include means of matching the commands received from the remote control and a software application being scanned.

The present invention is open to numerous variants. For example, other commands may of course be associated with remote control keys, in order to launch a virtual keyboard.

1. A multimedia system comprising:
a server an operating system configured to allocate resources thereof to software applications, the activation of which determined by a control application;
a client terminal including a display device and a remote control, the server and the client terminal including a first graphical interface and a second graphical interface, respectively, configured to communicate via an image-sharing protocol;
means for identifying commands related to the control application thereof in signals transmitted by the terminal via the first and second graphical interfaces so as to follow said commands, and
means for generating an image particular to the control application, so as to transmit said image to the terminal via the first and second graphical interfaces.

2. The system according, to claim 1, wherein the means for identifying commands related to the control application conform to the RFB image-sharing protocol.

3. The system according to claim 1, wherein the means for identifying commands are able to follow these commands, so as to deactivate an active application by means of the control application.

4. The system according to claim 3, wherein the means for identifying commands are able to follow these commands, so as to activate at least one Application by means of the control application.

5. The system according to claim 1, wherein the means for generating an image particular to the control application are able to represent, firstly, active applications and, secondly, disabled applications.

6. The system according to claim 1, wherein the first graphical interface and the second graphical interface include means for encoding their communication, according to an image-sharing protocol, with a data transmission protocol particular to a telecommunication network.

7. The system according to claim 1, wherein the terminal includes encoding means in signals transmitted to the server of commands issued by its remote control.

8. A server for a multimedia system comprising:
an operating system configured to manage the allocation of resources thereof to software applications, the activation of which can be determined by a control application;
a first graphical interface configured to communicate via an image-sharing protocol with a second graphical interface of a client terminal;
means for identifying commands related to the control application thereof in signals transmitted by the terminal via its graphical interface, so as to follow said commands, and
means for generating an image particular to the control application, so as to transmit this image to the terminal via its graphical interface.

9. A client terminal for a multimedia system comprising a display device, a remote control and a second graphical interface communicating via an image-sharing protocol with a first graphical interface of a server,
wherein the server, according to claim 8, includes:
means for displaying an image particular to the control application of the server transmitted via these graphical interfaces and
means for encoding commands related to the control application of the server in signals transmitted to this server via the graphical interfaces.

10. A management method for a multimedia system including:
a server including an operating system configured to manage the allocation of resources thereof to software applications, the activation of which determined by a control application and
a client terminal including a display device and a remote control, the server and the client terminal including a first graphical interface and a second graphical interface, respectively, configured to communicate via an image-sharing protocol, the method comprising
identifying by the server commands related to a control application thereof in signals transmitted by the terminal via graphical interfaces so as to follow said commands,
generating by the server an image particular to the control application so as to transmit said image to the terminal via the first and second graphical interfaces,
displaying by the terminal the image particular to the control application of the server transmitted via the first and second graphical interfaces and
encoding by the terminal commands related to the control application of the server in signals transmitted to said server via the graphical interfaces in a system according to claim 1.

11. A multimedia system comprising:
a server including an operating system configured to allocate resources thereof to software applications, the activation of which determined by a control application;
a client terminal including a display device and a remote control, the server and the client terminal including a first graphical interface and a second graphical interface, respectively, configured to communicate via an image-sharing protocol;
the first interface configured to identify a plurality of commands related to a control application thereof in signals transmitted by the terminal via the first and second graphical interfaces so as to follow said commands, and to generate an image particular to the control application, so as to transmit said image to the terminal via the first and second graphical interfaces.
